(19) United States
(12) Patent Application Publication
(10) Pub. No.: US 2010/0125528 A1
(43) Pub. Date: May 20, 2010

(54) SYSTEM AND METHOD TO SUPPLEMENT AND/OR MODIFY AN ISO QUALITY SYSTEM PROGRAM TO COMPLY WITH NUCLEAR POWER PLANT GOVERNMENT REGULATION REQUIREMENTS AND/OR STANDARDS ORGANIZATION REQUIREMENTS

(76) Inventor: Samuel K. REDDY, Fribourg (CH)

Correspondence Address: GREENBLUM & BERNSTEIN, P.L.C., 1950 ROLAND CLARKE PLACE, RESTON, VA, 20191, US

(21) Appl. No.: 12/618,978

(22) Filed: Nov. 16, 2009

Related U.S. Application Data
(60) Provisional application No. 61/199,486, filed on Nov. 15, 2008.

(51) Int. Cl. G06Q 50/00

(52) U.S. Cl. 705/317

(57) ABSTRACT

The present invention generally relates to quality system or quality assurance (QA) programs, and more particularly, to a system and method to supplement an ISO 9001-2000 quality assurance program to comply with at least one of nuclear power plant government regulation requirements and standards organization requirements. A method is implemented in a computer infrastructure having computer executable code tangibly embodied on a computer readable storage medium having programming instructions. The programming instructions are operable to perform a gap analysis of an organization's ISO quality assurance (QA) program to determine a gap between requirements of the organization's ISO QA program and at least one of nuclear power plant government regulation requirements and standards organization requirements. Additionally, the program instructions are operable to create a revised ISO QA program by at least one of supplementing and revising the organization's ISO QA program to bridge the gap, such that the revised ISO QA program is compliant with the at least one of the nuclear power plant government regulation requirements and the standards organization requirements.

### CROSS REFERENCE TO RELATED APPLICATION

The present application claims priority to U.S. Provisional Application No. 61/199,486 filed on Nov. 15, 2008, the disclosure of which is expressly incorporated by reference herein in its entirety.

### FIELD OF THE INVENTION

The present invention generally relates to quality system or quality assurance (QA) programs, and more particularly, to a system and method to supplement an ISO 9001-2000 quality assurance program to comply with the requirements of 10 C.F.R. 50 Appendix B and the requirements of ASME NQA-1.

### BACKGROUND

Spent nuclear fuel, occasionally called used nuclear fuel, is nuclear fuel that has been irradiated in a nuclear reactor (usually at a nuclear power plant) to the point where it is no longer useful in sustaining a nuclear reaction. Spent fuel is being reprocessed in Europe for approximately the last 30 plus years. Nuclear reprocessing separates components of spent nuclear fuel, for example, into various combinations of reprocessed uranium, plutonium, minor actinides, fission products, remnants of zirconium or steel cladding, activation products, and the reagents or solidifiers introduced in the reprocessing itself.

Spent nuclear fuel processing is done, for example, in a glove box environment that provides the containment and pressure boundary for the process units' glove boxes. A glove box is a sealed container that is designed to allow one to manipulate objects where a separate atmosphere is desired. Built into the sides of the glove box are gloves arranged in such a way that the user can place his or her hands into the gloves and perform tasks inside the box without breaking containment. Part or all of the box is usually transparent to allow the user to see what is being manipulated.

The glove box contains various items and/or components that are mechanical, structural, electromechanical, electronic, and software in nature. These items and/or components are manufactured and/or fabricated or developed globally, e.g., in Europe, by various large and small business entities in accordance with local standards including ISO 9001-2000 Quality System Program.

ISO 9000 is a family of standards for quality management systems that includes ISO 9001-2000, the contents of which are expressly incorporated by reference herein in their entirety. ISO 9000 is maintained by ISO, the International Organization for Standardization, and is administered by accreditation and certification bodies. The rules are updated, as the requirements motivate changes over time. A company or organization that has been independently audited and certified to be in conformance with ISO 9001 may publicly state that it is “ISO 9001 certified” or “ISO 9001 registered.” Certification to an ISO 9001 standard does not guarantee any quality of end products and services; rather, it certifies that formalized business processes are being applied.

10 C.F.R. 50 Appendix B, the contents of which are expressly incorporated by reference herein in their entirety, sets forth quality assurance criteria for nuclear power plants and fuel reprocessing plants. More specifically, 10 C.F.R. 50 Appendix B sets forth 18 quality assurance (QA) criteria for nuclear power plants and fuel reprocessing plants. The requirements of Appendix B apply to activities affecting safety related functions of the structures, systems and components of a nuclear plant. Such activities include, for example, designing, purchasing, fabricating, handling, shipping, storing, cleaning, erecting, installing, inspecting, testing, operating, maintaining, repairing, refueling and modifying. Quality assurance (QA) comprises all those planned and systematic actions necessary to provide adequate confidence that a structure, system or component will perform satisfactorily in service. QA includes quality control, which comprises those quality assurance actions related to the physical characteristics of a material, structure, component or system which provide an ability to control the quality of the material, structure, component or system to predetermined requirements.

In an effort to clarify the 18 criteria of Appendix B, the American Nuclear Standard Institute (ANSI) and the American Society of Mechanical Engineers (ASME), have developed standards for implementation of 10 C.F.R. 50 Appendix B. For example, ASME NQA-1, the contents of which are expressly incorporated by reference herein in their entirety, describes the 10 C.F.R. 50 Appendix B requirements and implementation of all 18 criteria. The NRC has issued Regulatory Guides (Reg. Guides) and endorsed the stated ANSI and ASME Codes (e.g., ASME NQA-1) for Quality Assurance (QA) Program Requirements of Nuclear Power Plants.

A review of the ISO 9001-2000 Quality System Program, however, indicates that the ISO 9001-2000 Quality System Program functions more as a process standard rather than a nuclear safety standard. Comparison of ISO 9001-2000 to the requirements of 10 CFR 50 Appendix B and ASME NQA-1 is documented by the United States Nuclear Regulatory Commission (USNRC) in Report No. SECY-03-0117 dated Jul. 9, 2003. This report indicates several inadequacies of ISO 9001-2000 in various areas including, for example, independent design reviews by suppliers, their multiple sub-tier suppliers, independent testing and inspection requirements, absence of audit of sub-tier suppliers, training requirements and software controls, amongst other inadequacies.

Due to these inadequacies, the USNRC does not accept the ISO Quality Systems Program as an alternative to 10 C.F.R. 50 Appendix B and ASME NQA-1 and hence does not endorse the ISO Quality Systems Program. This has caused a decline in suppliers, for example, of nuclear (e.g., sub sector) components, items and services. For example, companies that produce nuclear components using an ISO 9001-2000 Quality Systems Program, e.g., in Europe, are not able to sell those products in the United States, which requires compliance with 10 C.F.R. 50 Appendix B and ASME NQA-1. Additionally, for example, some suppliers of safety-related components have dropped their Appendix B programs to focus on larger commercial markets not subject to the Appendix B requirements. Consequently, the number of suppliers from which licensees can procure, e.g., safety-related parts and services, has declined.

Accordingly, there exists a need in the art to overcome the deficiencies and limitations described herein above.

### SUMMARY

In a first aspect of the invention, a method is implemented in a computer infrastructure having computer executable code tangibly embodied on a computer readable storage medium having programming instructions. The programming instructions are operable to perform a gap analysis of an organization's ISO quality assurance (QA) program to determine a gap between requirements of the organization's ISO QA program and at least one of nuclear power plant government regulation requirements and standards organization requirements. Additionally, the program instructions are operable to create a revised ISO QA program by at least one of supplementing and revising the organization's ISO QA program to bridge the gap, such that the revised ISO QA program is compliant with the at least one of the nuclear power plant government regulation requirements and the standards organization requirements.

In an additional aspect of the invention, a system implemented in hardware, comprises a gap analysis tool operable to perform a gap analysis of an organization's ISO quality assurance (QA) program to determine an existence of a gap between requirements of the organization's ISO QA program and at least one of nuclear power plant government regulation requirements and standards organization requirements, and an extent of the gap. Additionally, the system comprises a revise/supplement tool operable to create a revised ISO QA program by at least one of supplementing and revising the organization's ISO QA program to bridge the gap, such that the revised ISO QA program is compliant with the at least one of the nuclear power plant government regulation requirements and the standards organization requirements.

In an additional aspect of the invention, a computer program product comprising a computer usable storage medium having readable program code embodied in the medium is provided. The computer program product includes at least one component operable to perform a gap analysis of an organization's ISO quality assurance (QA) program to determine a gap between requirements of the organization's ISO QA program and at least one of nuclear power plant government regulation requirements and standards organization requirements. Additionally, the at least one component is operable to create a revised ISO QA program by at least one of supplementing and revising the organization's ISO QA program with at least one of a supplemental manual document and a supplemental procedure document to bridge the gap, such that the revised ISO QA program is compliant with the at least one of the nuclear power plant government regulation requirements and the standards organization requirements.

### BRIEF DESCRIPTION OF THE DRAWINGS

The present invention is described in the detailed description which follows, in reference to the noted plurality of drawings by way of non-limiting examples of exemplary embodiments of the present invention.

FIGS. 1-10 show exemplary gap analysis tables in accordance with aspects of the invention;

FIG. 11 shows an illustrative environment for implementing the steps in accordance with aspects of the invention; and

FIG. 12 shows an exemplary flow diagram in accordance with aspects of the invention.

### DETAILED DESCRIPTION

The present invention generally relates to quality system or quality assurance (QA) programs, and more particularly, to a system and method to supplement an ISO 9001-2000 quality assurance program to comply with the requirements of 10 C.F.R. 50 Appendix B (i.e., the 18 criteria) and the requirements of ASME NQA-1. In embodiments, the present invention is operable to provide, e.g., to an organization certified by ISO 9001-2000, a customized procedure for conversion of their existing ISO 9001-2000 program to comply with the nuclear power plant government regulation requirements set forth in 10 C.F.R. 50 Appendix B and/or standards organization requirements set forth in ASME NQA-1, e.g., on a nuclear plant sub sector level. The sub sector level of a nuclear plant includes components of (and or services for) a nuclear plant. For example, the nuclear sector includes the following primary sub sectors: nuclear facilities, nuclear materials, and nuclear waste. Moreover, each sub sector includes a number of segments. For example, the nuclear waste sub sector includes spent nuclear fuel processing and storage facilities segment, which includes facilities that store spent reactor fuel assemblies.

The present invention may be utilized, for example, by nuclear plant sub sector components, items and/or services providers (e.g., suppliers). A non-exhaustive list of sub sector level components, items and/or services include: glove boxes, manufacturing, valves, switches, and/or engineering services, amongst other sub sector level components, items and/or services. For example, a supplier of glove box components may use the present invention to supplement their ISO 9001-2000 quality system to comply with 10 C.F.R. 50 Appendix B, e.g., for new construction of glove boxes related to spent fuel and weapons grade nuclear material reprocessing.

By implementing the present invention, an organization may supplement and/or revise their ISO 9001-2000 quality system to comply with 10 C.F.R. 50 Appendix B and ASME NQA-1 requirements. Accordingly, by implementing the present invention, those organizations that utilize an ISO 9001-2000 quality system may offer services and/or products for a project requiring compliance with 10 C.F.R. 50 Appendix B and ASME NQA-1, without undergoing, for example, an entire ISO 9001-2000 system rewrite/certification. Additionally, those organizations who have dropped their Appendix B programs may implement the present invention to revise and/or supplement their ISO 9001-2000 program to offer services and/or products for a project requiring compliance with 10 C.F.R. 50 Appendix B. That is, using the present invention, an organization can identify those shortfalls, or gaps, (and the extent thereof) between their ISO 9001-2000 quality system and the 10 C.F.R. 50 Appendix B and/or ASME NQA-1, and supplement their ISO 9001-2000 quality system, e.g., with appropriate manual and procedure documents, to account for such gaps. Manual documents indicate what is performed to be compliant with the Appendix B requirements. For example, one such manual document is the organization chart (used to supplement the “organization” criteria), which sets forth the organizational structure of an organization. Procedure documents indicate how the QA program is implemented to be compliant with Appendix B.

The ISO 9000 standard is continually being revised, e.g., by standing technical committees and advisory groups. As such, the invention contemplates that the ISO 9001-2000 standards may change. Additionally, the invention contemplates that the requirements of 10 C.F.R. 50 Appendix B and/or ASME NQA-1 may be revised. Accordingly, while the present invention is described with respect to the current requirements and standards, it should be understood that the present invention may be configured to perform a gap analysis between any new revision of an ISO QA program and any new revision of nuclear power plant government regulation requirements currently set forth in 10 C.F.R. 50 Appendix B and/or ASME NQA-1 requirements.

### Exemplary Methodology

In embodiments, the method for customized conversion of an ISO 9001-2000 Quality System Program for compliance with 10 C.F.R. 50 Appendix B and ASME NQA-1 includes one or more of the following procedures:
a. perform a gap analysis;
b. revise/supplement the existing ISO 9001-2000 QA manual and procedures;
c. implement the revised ISO 9001-2000 QA manual and procedures;
d. perform internal audit and/or external audit of sub sector (or sub-tier) suppliers for compliance with the revised ISO 9001-2000 QA manual and procedures;
e. identify strengths and/or weaknesses;
f. determine corrective action based on the identified strengths and/or weaknesses; and
g. audit the corrective action.

In embodiments, some of the above-noted procedures may be implemented in a computer system. For example, as described below, a computer system may be configured to perform the gap analysis and/or the revising/supplementing of an organization's existing ISO 9001-2000 QA manual and procedures Additionally, some of the above-noted procedures may be performed manually.

### Gap Analysis

According to aspects of the invention, a gap analysis includes reviewing and understanding an organization's ISO 9001-2000 QA program and identifying areas that do not meet the 10 C.F.R. 50 Appendix B and ASME NQA-1 requirements. In embodiments, the gap analysis will involve a detailed review of each criterion in the existing ISO 9001-2000 Quality System manuals and procedures towards arriving at the areas of non-compliances as compared to the 18 criteria of 10 C.F.R. 50 Appendix B and ASME NQA-1 Quality Assurance Program requirements. Through performing a gap analysis, a report identifying the inadequacies under each existing criteria and/or missing criteria under the ISO 9001-2000 Quality System Program may be generated.

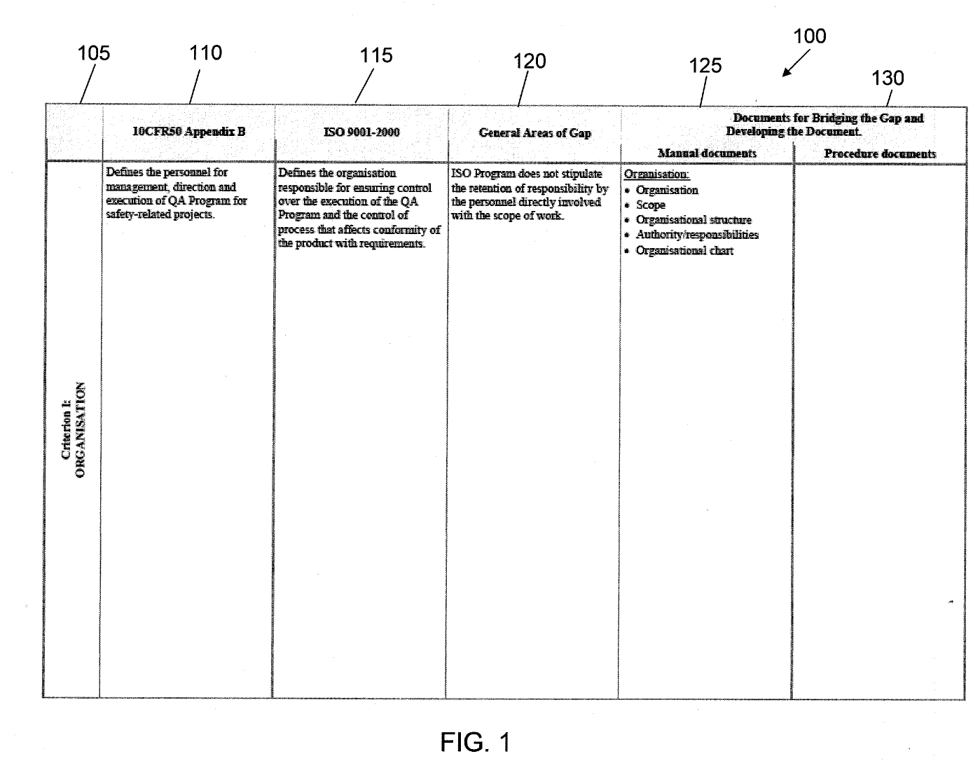

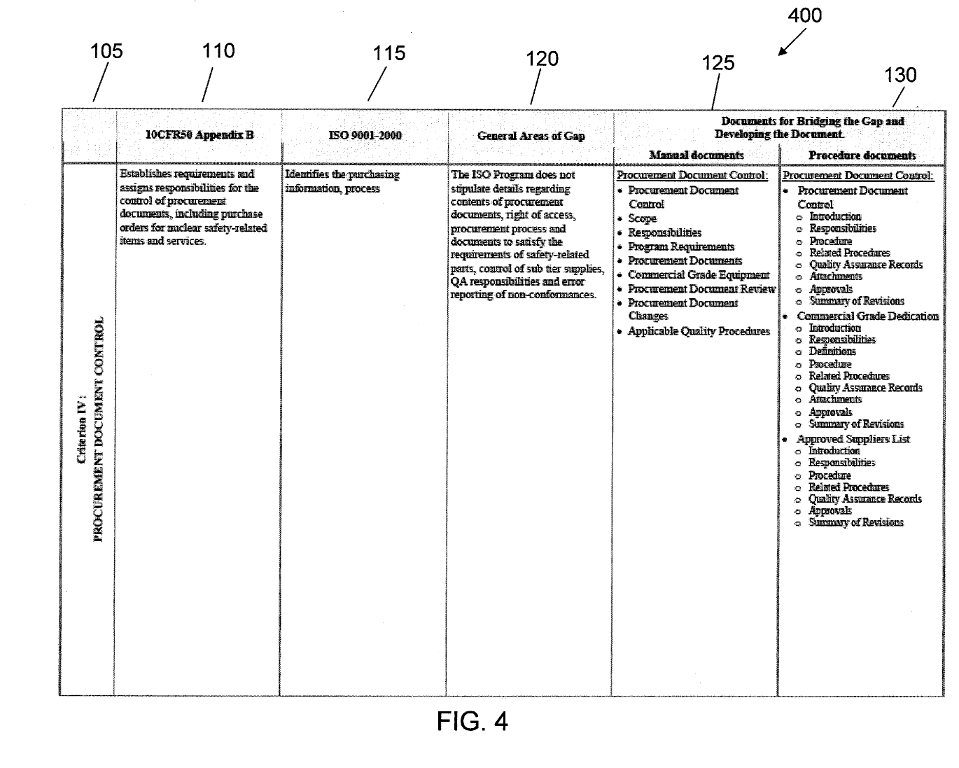

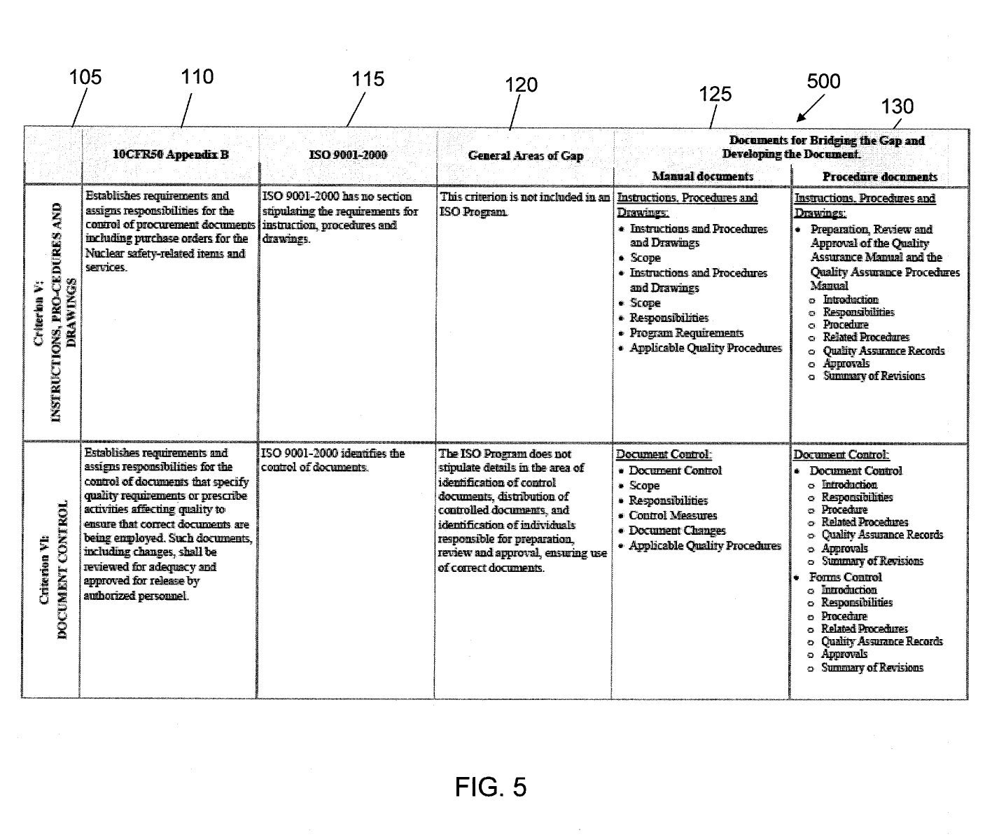

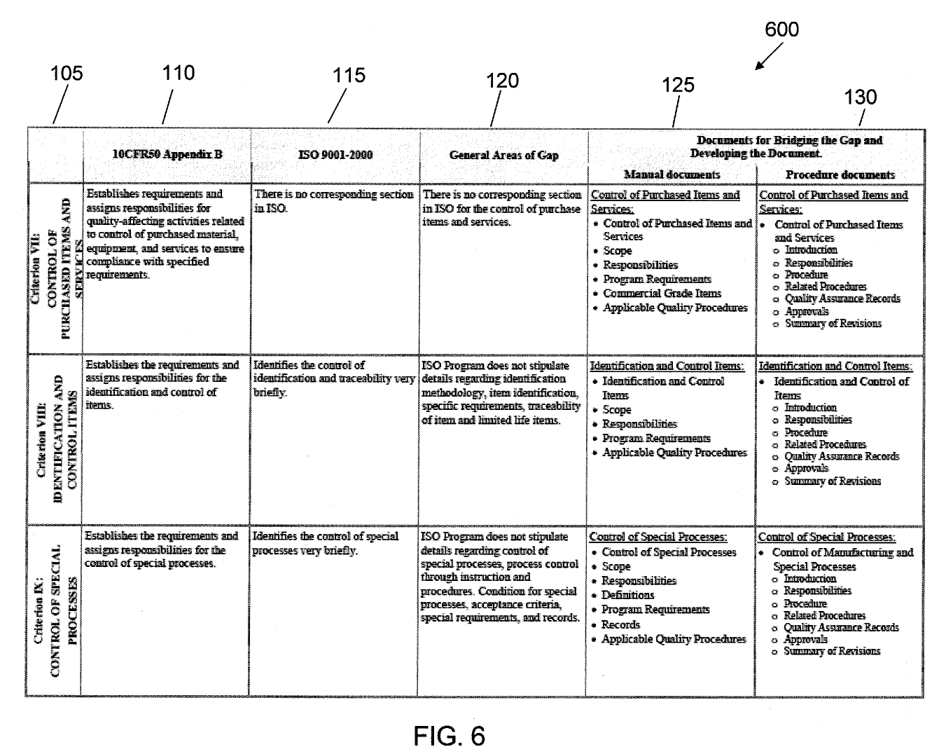

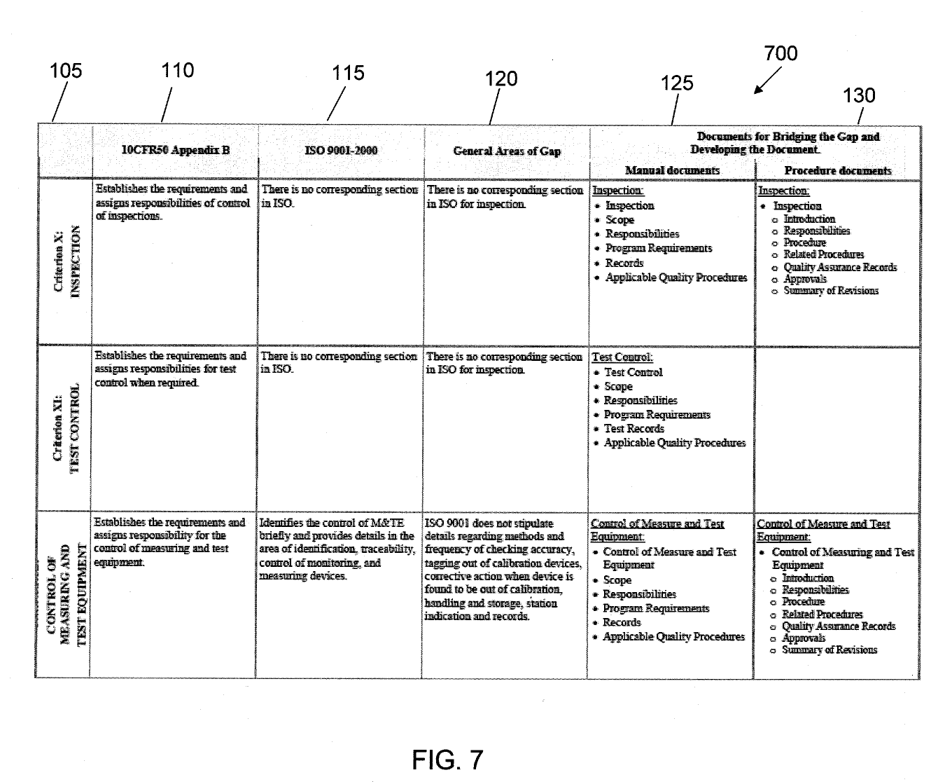

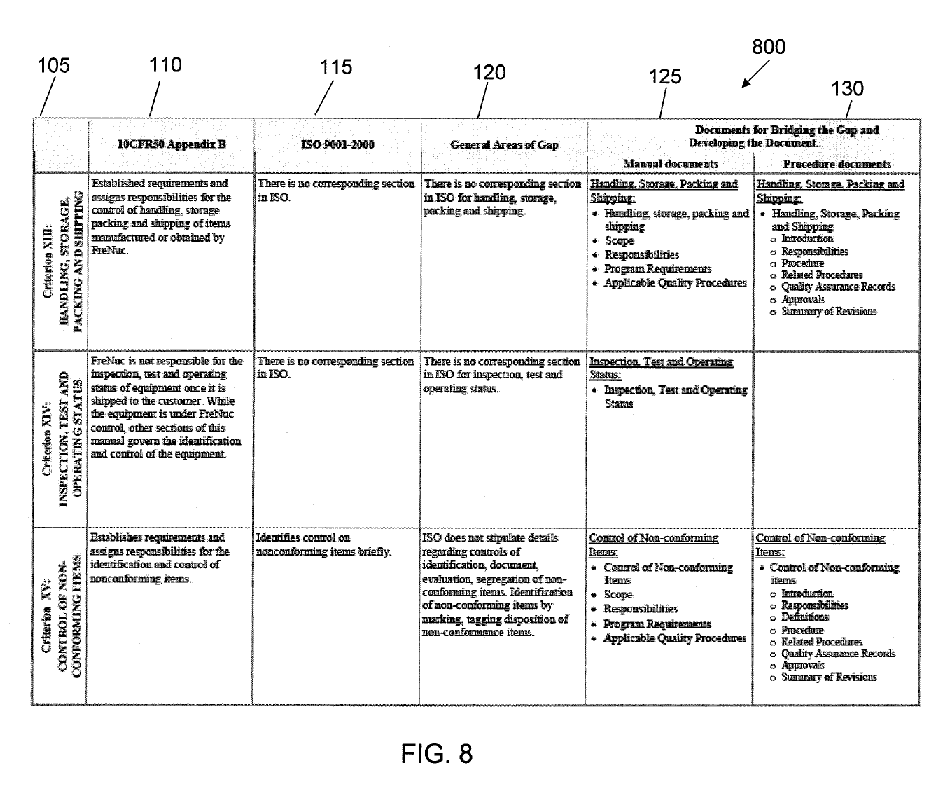

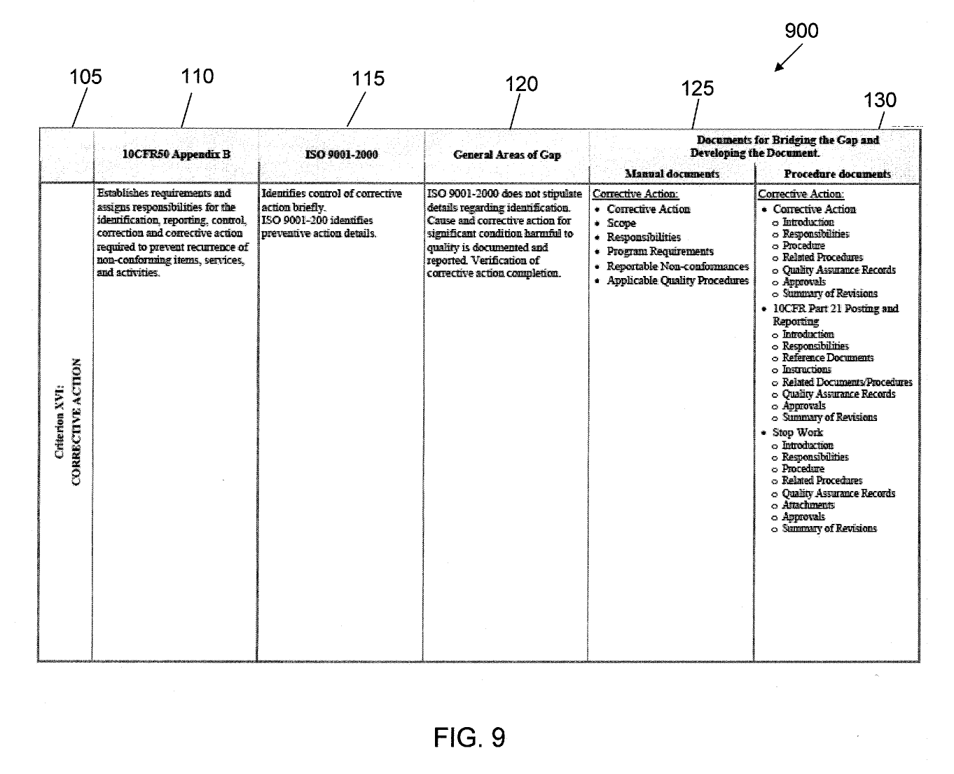

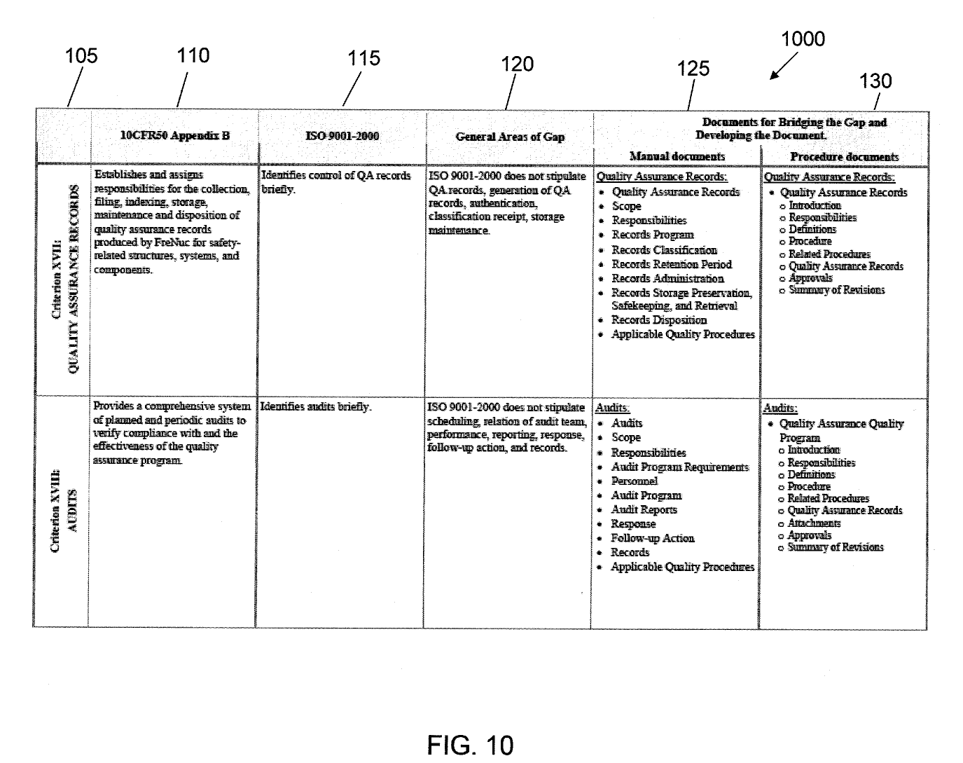

FIGS. 1-10 illustrate tables 100-1000, respectively, of an exemplary gap analysis between 10 C.F.R. 50 Appendix B and ISO 9001-2000 for the 18 criteria set forth in 10 C.F.R. 50 Appendix B in accordance with aspects of the invention. More specifically, as shown in FIG. 1, table 100 includes a criteria name column 105, which identifies the 10 C.F.R. 50 Appendix B criteria. A 10 C.F.R. 50 Appendix B column 110 sets forth the requirements of 10 C.F.R. 50 Appendix B. An ISO 9001-2000 column 115 sets forth a corresponding ISO 9001-2000 requirement of (if one exists). A general areas of gap column 120 sets forth the general areas of gap between the 10 C.F.R. 50 Appendix B and the ISO 9001-2000 requirement. In accordance with additional aspects of the invention, table 100 includes an indication of documents for bridging the gap and or items for developing the documents. A manual documents column 125 indicates supplemental manual documents and a procedure documents column 130 indicates supplemental procedure documents.

As noted above, 10 C.F.R. 50 Appendix B sets forth 18 criterion for compliance therewith. These 18 10 C.F.R. 50 Appendix B criterion include: (1) organization; (2) quality assurance (QA) program; (3) design control; (4) procurement document control; (5) instructions, procedures, and drawings; (6) document control; (7) control of purchased items and services; (8) identification and control items; (9) control of special processes; (10) inspection; (11) test control; (12) control of measuring and test equipment; (13) handling, storage, packing and shipping; (14) inspection, test and operating status; (15) control of non-conforming items; (16) corrective action; (17) quality assurance records; and (18) audits.

As shown in FIG. 1, for example, table 100 sets forth an exemplary gap analysis for the “organization” criteria. Under 10 C.F.R. 50 Appendix B, the organization criteria defines the personnel for management, direction and execution of QA Program for safety-related projects. Moreover, as shown in FIG. 1, the corresponding ISO 9001-2000 requirement defines the organization responsible for ensuring control over the execution of the QA program and the control of process that affects conformity of the product with requirements. However, as indicated in the general areas of gap column 120, the ISO program does not stipulate the retention of responsibility by the personnel directly involved with the scope of work. As such, in order for the ISO program to be compliant with 10 C.F.R. 50 Appendix B, the ISO program should be supplemented.

In accordance with further aspects of the invention, as shown, for example, in FIG. 1, the present invention indicates those documents (e.g., manual or procedure documents) that may be necessary to supplement the ISO program. Manual documents include those documents that would supplement the organization's QA manual. Procedure documents set forth QA procedures. Thus, for example, as shown in FIG. 1, with regard to the “organization” criteria, table 100 identifies manual documents necessary to supplement the ISO program to satisfy the organization criteria of 10 C.F.R. 50 Appendix B. In embodiments, these supplemental manual documents may include: organization, scope, organizational structure, authority and/or responsibilities and/or an organizational chart. Additionally, as shown in FIG. 1, there are no supplemental procedure documents for the “organization” criteria. In embodiments, as described below, the present invention may provide a hyper link to such supplemental documents for bridging the gap and developing the QA documents.

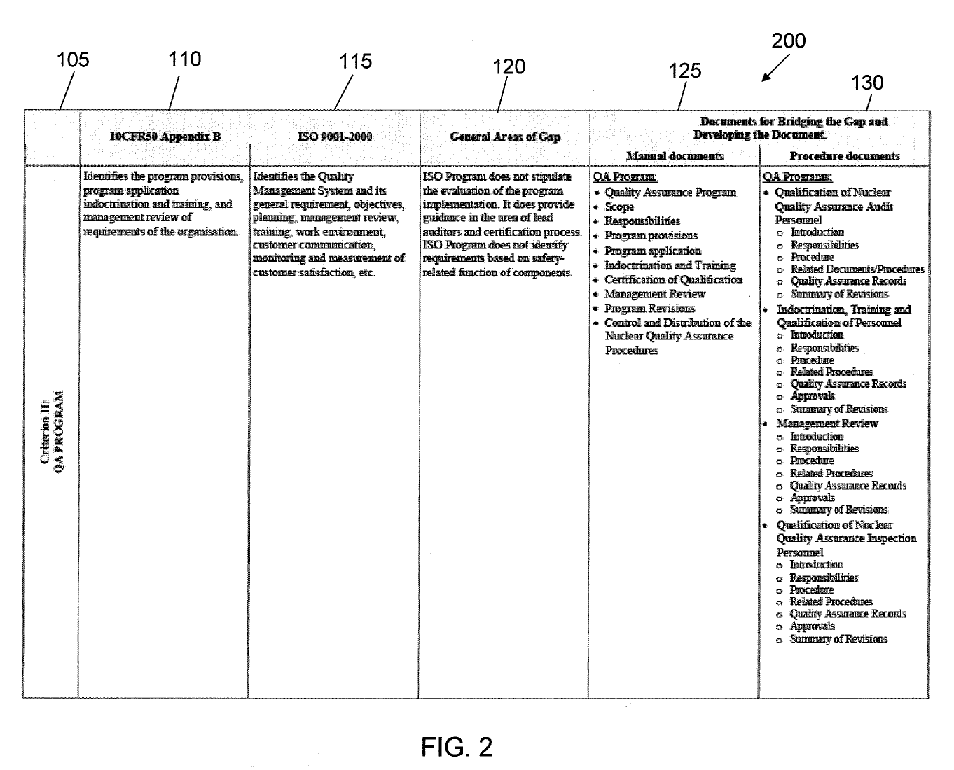

FIGS. 2-10 show additional tables 200-1000, respectively, setting forth an exemplary gap analysis for the remainder of the 18 10 C.F.R. 50 Appendix B criteria. As FIGS. 2-10 are similar to FIG. 1, no further description of FIGS. 2-10 is necessary for those of ordinary skill in the art to practice the present invention.

In accordance with additional aspects of the invention, in embodiments, a gap analysis for a particular organization may include identification of additional gaps to those gaps shown in the exemplary gap analysis of FIGS. 1-10. That is, the gap analysis between the ISO 9001-2000 Quality System Program and 10 C.F.R. 50 Appendix B and/or ASME NQA-1 (e.g., as set forth in FIGS. 1-10) will identify gaps for an ideal organization (i.e., an organization that is fully compliant with ISO 9001-2000 Quality System Program requirements). In actuality, however, an organization may be certified as ISO 9001-2000 compliant, but nonetheless, may not actually be compliant with each of the ISO 9001-2000 program requirements. Thus, a gap analysis for such an organization may identify additional gaps between the organization's ISO 9001-2000 Quality System Program and 10 C.F.R. 50 Appendix B and/or ASME NQA-1. Additionally, the gap analysis for such an organization may identify additional manual documents and/or procedure documents based on the additionally identified gaps.

### Revise and/or Supplement an Existing QA Manual

According to further aspects of the invention, an organization's existing QA manual and QA procedures are revised and/or supplemented with the documents (e.g., manual documents and/or procedure documents) identified using the gap analysis in order to comply with the 18 criteria of 10 C.F.R. 50 Appendix B program (and ASME NQA-1). For example, in embodiments, the revision to the existing ISO Quality System Program may involve a customized revision specific to a sub sector (e.g., components the glove box environment, which provides the criticality prevention, structural integrity and containment pressure boundary for the process units' glove boxes).

To provide an example of supplemental “manual” documents, using the “organization” criteria as an example, as shown in FIG. 1, the supplemental manual documents necessary to bridge an identified gap for the “organization” criteria may include: an identification of organization scope section, an organizational structure section, an authority/responsibilities section, an organization chart section and an applicable quality procedures section. The “organization scope” section identifies the Company organization for the management, direction, and execution of the quality assurance program for nuclear safety-related projects. The organization structure identifies Company personnel responsible for ensuring that an appropriate quality assurance program is established and verifying that activities affecting quality have been correctly performed have sufficient authority, access to work areas, and organizational freedom and independence to: identify quality problems; initiate, recommend, or provide solutions to quality problems through designated channels; verify implementation of solutions to quality problems; and assure that further processing, testing, delivery, installation, or operation is controlled until proper disposition of nonconformance or deficiency has occurred. Additionally, the organizational document states that quality personnel are independent of the pressures of production, cost, and schedule when safety considerations are involved. Furthermore, the organizational document states that the Quality Assurance Manager reports directly to the Company President, therefore appropriate authority and organizational freedom is provided.

The “authority/responsibilities” section of the “organization” criteria manual document sets forth the authority and/or responsibilities of the organization as it pertains to quality assurance. For example, the authority/responsibilities portion may set forth authority and/or responsibilities for a president, a management representative, a quality assurance manager, and an operations manager of an organization, amongst other personnel for nuclear projects (e.g., production control, purchasing, quality control personnel). An organization chart may set forth the organizational structure of the organization. The “applicable quality procedures” section sets forth company quality procedures that are applicable to the company.

Using the “quality assurance program” criteria as a further example of the supplemental manual documents identified and provided by the present invention, as shown in FIG. 2, the manual documents necessary to bridge an identified gap for the “quality assurance program” criteria may include sections for: scope, responsibilities, program provisions, program application; indoctrination and training, certification of qualification, management review, program revisions, control and distribution of the nuclear quality assurance manual and quality assurance procedures and applicable quality procedures. The scope section identifies the program provisions, program application, indoctrination and training, and management review requirements of the Company quality program.

The “responsibilities” section sets forth the QA responsibilities for, e.g., a president, a quality assurance manager, and an operations manager of an organization, amongst other personnel for nuclear projects. For example, the responsibilities section may indicate that the president is responsible for the Company quality assurance program, and approves the Quality Assurance Manual (e.g., as supplemented by the present invention), nuclear quality procedures and any revisions to the manuals. Additionally, the responsibilities section may indicate that the Quality Assurance Manager is responsible for verifying that the quality assurance program is implemented with regard to all nuclear safety-related activities performed by Company. Furthermore, the responsibilities section may indicate that the Operations Manager is responsible for developing and approving project specific documents and determines the need for formal training for personnel performing or managing activities affecting quality.

The “program provisions” section provides that the quality assurance program establishes the basic operating policies and specifies the requirements for implementing procedures to be employed by a Company to comply with the applicable requirements of the latest versions of 10 C.F.R. 50 Appendix B; 10 C.F.R. Part 21; ASME NQA-1; and other recognized and appropriate engineering codes, standards, requirements, and practices; and with special contractual requirements imposed by the client. Additionally, the program provisions section states that the quality assurance program ensures that activities affecting quality are recorded within the document control system and are accomplished in accordance with written and approved instructions, procedure, or drawings. Furthermore, the program provisions section may state that personnel performing activities affecting quality shall be trained, qualified and certified and that indoctrination and training is provided, as necessary, to ensure that suitable proficiency is achieved and maintained. All such indoctrination and training is documented in appropriate training records and files. Personnel performing special processes are certified in accordance with the applicable codes and standards. The program provisions section also provides that, if an outside organization retained by the Company for nuclear safety-related work does not have a quality program meeting the requirements of this manual, the Company quality assurance program shall be implemented by prior agreement between both parties. The outside organization's employees working on the project shall be trained in the applicable requirements of this program. The Company Quality Assurance Manager has the freedom to verify proper implementation of this program by the outside organization

The “program application” section of the “quality assurance program” criteria manual documents may set forth to what the QA program applies. Thus, this section may indicate the quality assurance program is applied to all nuclear safety-related activities when required by contract or purchase order, or is deemed appropriate by Company, and that, once the quality assurance program in invoked, it shall be implemented for the life of the contract or purchase order.

The “indoctrination and training” section of the “quality assurance program” criteria manual documents may set forth the indoctrination and training requirements for those implementing the companies QA program. For example, the indoctrination and training section may indicate that personnel assigned to perform activities, under this quality assurance program, are given appropriate indoctrination and training prior to performing those activities. Additionally, the indoctrination and training section may indicate that the indoctrination and training includes, as applicable, the purpose, scope and implementation of the quality assurance program elements that are to be employed, the applicable implementing procedures, as well as the technical objectives and requirements of the applicable codes and standards.

The “certification of qualification” section of the “quality assurance program” criteria manual documents may set forth the qualification of inspection, test, and Lead Auditor personnel certified in writing. In embodiments, the certification of qualification section may include the following information: employer's name, identification of person being certified, activities certified to perform, and a basis for qualification, including education, experience, indoctrination, and training; test results, where applicable; and/or capability demonstration results. Additionally, the certification of qualification section may include results of periodic evaluation, results of physical examinations, when required; a signature of employer's designated representative who is responsible for such certification; and date of certification or recertification and certification expiration.

The “certification of qualification” section of the “quality assurance program” criteria manual documents may also state that the company identifies any special physical characteristics needed to perform each activity, including the need for initial and subsequent physical examination and that the company may delegate qualification examination activities to an independent certifying agency, but retains responsibility for conformance of the examination and its administration. The certification of qualification section may also set forth that the company retains copies of objective evidence regarding the type(s) and content of examination(s).

Additionally, the certification of qualification section sets forth records of indoctrination and training, which, in embodiments may take the form of attendance sheets, training logs, and/or personnel training records. The certification of qualification section may also state that records of qualification, including requalification, for auditors and Lead Auditors and for inspection and test personnel are established and maintained by the company.

The “management review” section of the “quality assurance program” criteria manual documents sets forth the particulars of management review. For example, the management review section may indicate that the Management system is reviewed at planned intervals to ensure its continuing suitability, adequacy and effectiveness and to evaluate the need for change. Additionally, the management review section may indicate that the review is performed by the President, with inputs from the Quality Assurance Manager, the Operations Manager, and other responsible members, as requested by the President. Further, the management review section may indicate that in addition to the requirements of the ISO 9001-2000 quality program, the following subjects are to be considered, as a minimum: 10 CFR Part 21 Reporting Nonconformance and Corrective Actions, and computer error reports. Additionally, the management review section may indicate that the discussion and results of the meeting is documented and the Quality Assurance Manager shall follow-up on any discrepancies or inadequacies identified in the quality assurance program as a result of this review, wherein corrective action will be assigned to responsible management for implementation.

The “program revisions” section of the “quality assurance program” criteria manual documents sets forth the requirements for program revisions. For example, the program revisions section may set forth that requests for quality assurance program revisions may be made by any Company employee or client, and that the Quality Assurance Manager evaluates program revision requests and implements any required program revisions. Additionally, the program revisions section may specify that Quality assurance program revisions are reviewed and approved by the Company President.

The “control and distribution of the nuclear QA manual and QA procedures” section of the “quality assurance program” criteria manual documents sets forth the requirements for program revisions. For example, this section may indicate that the Quality Assurance Manual, Procedures, project instructions and procedures, and approved revisions thereto, are issued as controlled documents in accordance with this quality program. An “applicable quality procedures” section may identify Company quality procedures which are applicable to Quality Assurance Program. For example, the “applicable quality procedures” section may reference NQAM, Section, 17, Quality Assurance Records, NP2-1, Qualification of Quality Assurance Program Audit Personnel, PRM-03, Resources, PR-02, Liquid Penetrant Inspection Process, and/or Form QF02-01, Management Review Meeting Agenda. These documents are understood by those of ordinary skill in the art of nuclear plant QA, such that further description of these documents is not necessary for those having ordinary skill in the art to practice the present invention.

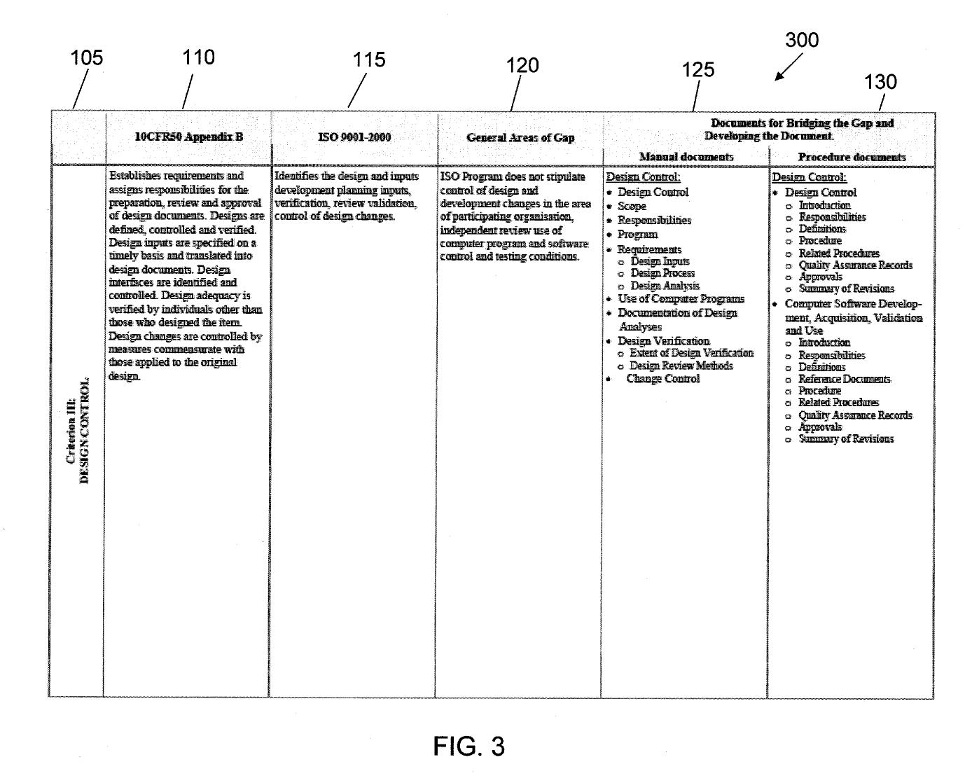

To provide an example of supplemental “procedure” documents, using the “design control” criteria as an example, as shown in FIG. 3, the supplemental procedure documents necessary to bridge an identified gap for the “design control” criteria may include sections for: introduction, responsibilities, definitions, procedure, related procedures, quality assurance records, approvals and a summary of revisions. The “introduction” section sets forth the purpose of a procedure. For example, the introduction section may indicate that the purpose of this procedure is to establish the responsibilities and methodology used by Company for control of design documents that define quality requirements or prescribe activities which affect quality to ensure that clients' specifications and purchase orders, Company quality assurance program and all applicable codes and standards are met. Additionally, the introduction section may indicate that documents are prepared by competent personnel assigned by the Project Engineer, reviewed by an independent qualified person or group and approved by the Project Engineer, or his designee.

The “responsibilities” section sets forth the responsibilities of those overseeing aspects of the QA program. For example, the “responsibilities” section may indicate the Quality Assurance Manager is responsible for verifying that the requirements of this procedure are implemented in accordance with the Quality Assurance Manual and the Project Manager is responsible for identifying the project scope of work, in the Project Plan, for the completion of design activities on his assigned project. Additionally, the “responsibilities” section may indicate that the Project Manager is responsible for controlling project documents, including transmittal to the client and forwarding them to Document Control, that Document Control is responsible for indexing, filing, and retention of completed projects in accordance with NP17-1, and that Company personnel assigned to a project are responsible for completion of the project in accordance with the requirements specified in the Project Plan and supplemental technical requirements in applicable Project Instructions. The “definitions” section sets forth definitions, for example, for “approved design input,” “preliminary design input” and “certified design input, amongst other terms.

The “procedure” section sets forth procedures. For example, such procedures may include a project plan, project instructions, interface control, design input, preliminary design input, design and analysis documentation, design and analysis output, computer-aided design and analysis, design and analysis verification, verification of calculations and reports, verification of design drawings, design change control, design control records, and provision for control of contractors and subcontractors, amongst other procedures.

The “related procedures” section sets forth related procedures. Such related procedures may include, for example, NP2-2, Indoctrination, Training and Qualification of Personnel, NP2-4, Certification of Personnel Engaged in ASME Section III Certifying Activities, NP3-2, Computer Software Acquisition, Validation, and Use, NP4-1, Procurement Document Control, NP6-1, Document Control, NP15-1, Nonconforming Product, NP16-1, Corrective Action and/or NP17-1, Quality Assurance Records.

The “quality assurance records” section sets forth quality assurance records. Such quality assurance records may include, for example, a Project Plan, Form NF3-1.1, Design and Analysis Using Preliminary Design Input, Form NF3-1.2, Design Input Log, Form NF3-1.3, Calculation Package, Form NF3-1.4, Reviewer's Checklist for Design Calculations and Form NF3-1.5, Reviewer's Checklist for Design Drawings, amongst other quality assurance records. These quality assurance records are understood by those of ordinary skill in the art of nuclear plant QA, such that further description of these documents is not necessary for those having ordinary skill in the art to practice the present invention.

The “approvals” section sets forth an area for approvals for, e.g., preparation, review, approval and acceptance of the “design control” criteria procedure documents. Additionally, the “summary of revisions” section provides an area to indicate any revisions to the “design control” criteria procedure documents.

The above-discussed-manual documents (e.g., for the “organization” criteria and the “quality assurance program” criteria) and procedure documents (e.g., for the “design control” criteria) are intended as examples of such documents. As should be understood, the invention contemplates other manual and procedure documents for the other of the 18 criteria of Appendix B, for example, as listed in FIGS. 1-10. One of ordinary skill in the art of would readily understand what is encompassed by each of the listed documents of FIGS. 1-10, such that explanation of each of such documents is not necessary for those of ordinary skill in the art to practice the present invention.

In embodiments, the present invention is operable to provide hyperlinks to documents identified as necessary for bridging the gap. In additional embodiments, the present invention may retrieve such identified documents (e.g., manual and procedure documents) from a storage system (e.g., a database) containing such documents, as described below.

### Implement Revised and/or Supplemented QA Manual

According to further aspects of the invention, the revised QA Program is implemented. The implementation process will involve implementing all the 18 criteria, e.g., at the sub sector level.

### Internal and External Audits

According to further aspects of the invention, an audit process is performed to determine compliance with the requirements of 10 C.F.R. 50 Appendix B (and ASME NQA-1). In embodiments, the audit process includes both an internal audit and an external audit of sub-tier suppliers for compliance. For example, a detail internal and external audit will be conducted after implementation of the revised QA program to ensure that all the 18 criteria are implemented at the subsector level.

### Identify Strengths and Weaknesses

According to further aspects of the invention, the detailed audit identifies any weakness and/or strengths of the newly implemented revised QA program. For example, the audit report will document the weakness and/or strengths for each of the 18 criteria. Additionally, the documented weaknesses and/or strengths may be used to determine appropriate recommendations to arrive at corrective actions.

### Corrective Action Determination

According to further aspects of the invention, corrective actions may be determined, e.g., by an auditor. In embodiments, the audit report will contain the corrective actions for findings and areas of weaknesses. Additionally, in embodiments, the present invention provides timelines for implementation of the corrective actions and action to prevent recurrence of the weaknesses. Such corrective actions (and the areas of weakness that prompted the corrective actions) may be stored in a storage system (e.g., a database), such that a historical database of areas of weakness and corresponding corrective actions is developed. With a historical database, an auditor may, for example, access the historical database to determine an appropriate corrective action (e.g., a corrective action that was previously used for a similar area of weakness).

Additionally, in embodiments, a computer system may be configured to compare areas of weakness of a particular organization's modified QA program, with those areas of weakness identified in the historical database. The computer system may then automatically suggest (and/or perform) corrective actions for the particular areas of weakness based on the corrective actions listed in the historical database.

### Audit Corrective Action

Additionally, in embodiments, an auditor may perform an audit of the corrective action. For example, the corrective actions implementation may be audited for completeness and compliance to the timelines provided.

### System Environment

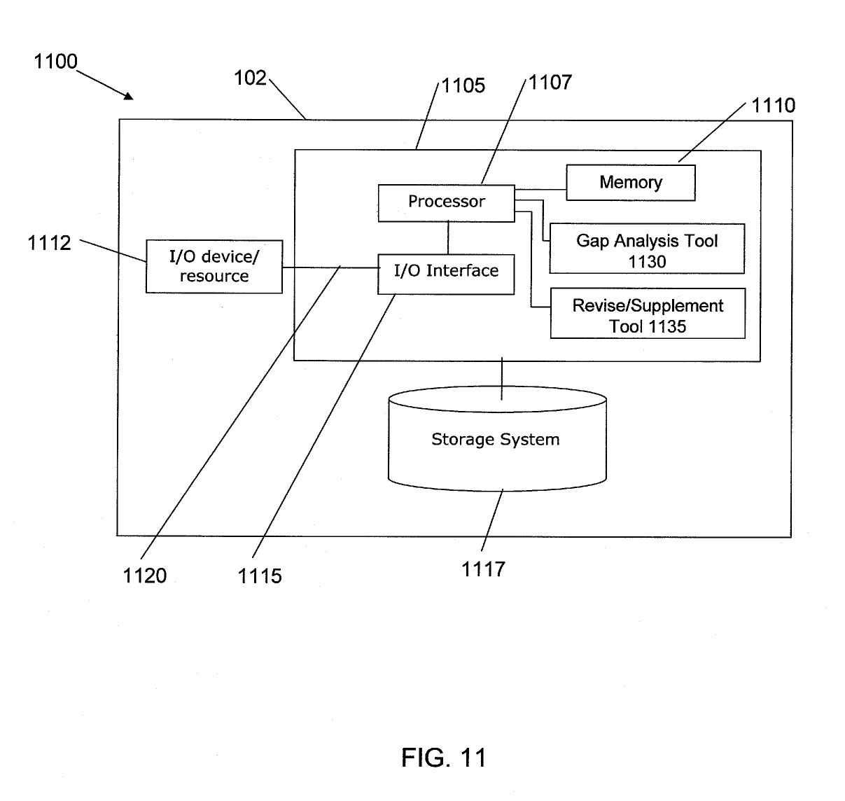

FIG. 11 shows an exemplary computer system environment 1100 for implementing aspects of the present invention. As shown in FIG. 11, the exemplary computer system environment 1100 includes a computer infrastructure 1102 that is operable to perform the processes described herein using a computing device 1105. The computing device 1105 includes a processor 1107, a memory 1110, an input/output (I/O) interface 1115, and a bus 1120. The bus 1120 provides a communications link between each of the components in the computing device 1105.

Additionally, the computer system environment 1100 includes a storage system 1117, e.g., a database. While only one storage system 1117 is shown, it should be understood that the computer infrastructure 1102 may include any number of storage systems 1117. Moreover, it should be understood that, in embodiments, the storage system 1117 may include a local storage system and/or a remote storage system.

The processor 1107 executes computer program code processes on computer media, which may be stored in memory 1110 and/or storage system 1117. While executing computer program code, the processor 1107 can read and/or write data to/from memory 1110, storage system 1117, and/or I/O interface 1115. The memory 1110 may include, for example, local memory employed during actual execution of program code, bulk storage, and cache memories which provide temporary storage of at least some program code, for example, in order to reduce the number of times code must be retrieved from bulk storage during execution.

Further, the computing device 1105 is in communication with an external I/O device/resource 1112. The I/O device 1112 can interact with the computing device 1105 or any device that enables the computing device 1105 to communicate with one or more other computing devices using any type of communications link. In embodiments, the external I/O device/resource 1112 may be, for example, keyboards, displays, pointing devices, etc.

The computing device 1105 can comprise any general purpose computing article of manufacture capable of executing computer program code installed thereon (e.g., a personal computer, server, handheld device, etc.). However, it should be understood that the computing device 1105 is only representative of various possible equivalent computing devices that may perform the processes described herein. To this extent, in embodiments, the functionality provided by the computing device 1105 can be implemented by a computing article of manufacture that includes any combination of general and/or specific purpose hardware and/or computer program code. In each embodiment, the program code and hardware can be created using standard programming and engineering techniques, respectively.

As should be understood, the computer infrastructure 1102 is illustrative of various types of computer infrastructures for implementing the invention. For example, in embodiments, the computer infrastructure 1102 comprises two or more computing devices (e.g., a server cluster) that communicate over any type of communications link, such as a network, a shared memory, or the like, to perform the processes described herein.

As will be appreciated by one skilled in the art, the present invention may be embodied as a system, method or computer program product. In embodiments, the present invention may take the form of an entirely hardware embodiment, an entirely software embodiment or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, or device. Examples of a computer-readable storage medium include magnetic tape, a removable computer diskette, a random access memory (RAM), a read-only memory (ROM), a rigid magnetic disk, a semiconductor or solid state memory, and an optical disk. Current examples of optical disks include compact disk read only memory (CD-ROM), compact disc-read/write (CD-R/W) and DVD.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages.

As shown in FIG. 11, the computing device 1105 also includes a gap analysis tool 1130 and a revise/supplement tool 1135. The gap analysis tool 1130 is operable to perform a gap analysis and determine an extent of an existing gap. The revise/supplement tool 1135 is operable to identify, supply, revise and/or supplement an organization's ISO QA program with supplemental documents (for example, manual documents and/or procedure documents), e.g., the processes described herein. The gap analysis tool 1130 and the revise/supplement tool 1135 can be implemented as one or more program code in the program control stored in memory 1117 as separate or combined modules.

### Gap Analysis Tool

In accordance with aspects of the invention, the gap analysis tool 1130 is operable to determine the existence and/or the extent of a gap between an organization's ISO QA program and a 10 C.F.R. 50 Appendix B program (or ASME NQA-1 program). In embodiments, the gap analysis tool 1130 may access the exemplary gap analysis tables 100-1000 (described above), which may be stored in storage system 1117 (e.g., a database). Additionally, in embodiments, the gap analysis tool 1130 is operable to provide a questionnaire (e.g., one or more questions) and receive answers to the questionnaire in order to determine the existence and/or the extent of a gap. As noted above, in embodiments, exemplary gap analysis tables 100-1000 may be considered a starting point for the gap analysis. That is, for example, an organization with an ISO QA program will likely have a gap with the 10 C.F.R. 50 Appendix B program “organization” criteria. For example, as indicated in FIG. 1 in the general areas of gap column 120, the ISO program does not stipulate the retention of responsibility by the personnel directly involved with the scope of the work.

However, the extent of an existing gap may vary widely between different organizations. For example, the extent of a gap may vary depending on, e.g., a particular organization's extent of compliance with the ISO QA program (e.g., less than fully compliant), and any additional documentation the particular organization may already possess and/or an organizational structure of the particular organization, amongst other variables.

As such, in accordance with aspects of the invention, the gap analysis tool 1130 is configured to perform a gap analysis, which, in embodiments, includes a determination of an extent of the determined gap. In embodiments, the gap analysis tool may provide questions to a user and receive the user's inputs in order to determine an extent of a gap. For example, the gap analysis tool 1130 may receive user inputs to determine whether an organization is fully compliant with the requirements of ISO 9001-2000. If the gap analysis tool 1130 determines that the organization is fully compliant with the requirements of ISO 9001-2000, the gap analysis tool will identify the gaps between the organization's fully compliant ISO 9001-2000 program and 10 C.F.R. 50 Appendix B, for example, as set forth in the exemplary gap analysis tables 100-1000. If the gap analysis tool 1130 determines that an organization is not fully compliant with the requirements of ISO 9001-2000, the gap analysis tool will identify additional gaps (and the extent if such gaps) to those gaps as set forth in the exemplary gap analysis tables 100-1000.

For example, an additional gap that may be identified by the present invention may include the ISO program not stipulating that the organizational structure is based on functional responsibilities, level of authority and/or chain of command/communication for activities affecting quality. As a further example of an additional gap, the ISO program may not stipulate independency of personnel performing the verification of the quality requirements. Additionally, the ISO program may not define the individuals responsible for the verification of the quality compliance. Further, the ISO Program may not stipulate direct access to work to perform this function, and ISO Program may not stipulate access to work to perform their function. Additionally, the ISO Program may not stipulate that personal responsibilities for achieving quality shall not be directly responsible for performing the work. It should be understood that this list of additional gaps is exemplary and non-exhaustive, and the present invention contemplates other additional gaps.

In accordance with aspects of the present invention, some exemplary questions that may be included in a questionnaire in order to determine the existence of a gap, the extent of a gap and/or additional gaps, include “Does the company identify its organization for: (a) management; (b) direction; and (c) execution?” with input fields for “yes” and “no” for each of (a), (b) and (c). As a further example, a questionnaire may include, “Does the company organization chart demonstrate: (a) specific levels of authority?; (b) specific levels of communication for activities affecting quality?” with input fields for “yes” and “no” for each of (a) and (b). Additionally, a questionnaire may include “Does the organization chart identify QA personnel responsible for ensuring that an appropriate QA program is established and . . . (a) Verify that the activities affecting quality have been correctly performed?; (b) Perform by sufficient authority?; (c) Access to work area?; (d) Organizational freedom and independence to identify problems identify and recommend solutions through designated channels?; (e) Verify implementation of solution to Quality problems?” with input fields for “yes” and “no” for each of (a), (b), (c), (d) and (e). Moreover, a questionnaire may include “Are the quality personnel independent of the pressures of production, cost of schedule when safety considerations are involved?” with input fields for “yes” and “no.” Also, a questionnaire may include “Does the QA Manager report directly to the management of the company?” with input fields for “yes” and “no.” In embodiments, by presenting a questionnaire to a user (e.g., an organization) and receiving inputs to the questions of the questionnaire, the gap analysis tool 1130 is operable to identify, for example, the existence of a gap, the extent of a gap and/or additional gaps

### Revise/Supplement Tool

In accordance with additional aspects of the invention, the revise/supplement tool 1135 is operable to receive the gap analysis from the gap analysis tool 1130, and provide, e.g., an organization, with the necessary documents (e.g., manual and/or procedure documents) to supplement the organization's ISO QA program based on the information from the gap analysis tool 1130. Thus, turning to FIG. 1, for example, if the gap analysis tool 1130 identifies a gap for the organization criteria, the revise/supplement tool 1135 will provide the manual and procedure documents listed in columns 125 and 130. With this example, for an “organization” criteria gap, the revise/supplement tool 1135 will provide manual documents, as no procedure documents are necessary for bridging the organization gap. For example, the manual documents necessary to bridge a gap for the organization criteria include: organization, scope, organizational structure, authority/responsibilities and organization chart. The contents and make-up of such documents listed in columns 125 and 130 of FIGS. 1-10 are well understood by those of ordinary skill in the art of QA programs, such that further description of these documents are not necessary for those skilled in the art to practice the present invention. Upon completing and/or implementing these documents provided by the revise/supplement tool 1135, an organization will effectively bridge any gaps between their ISO 9001-2000 QA program and the requirements of 10 C.F.R. 50 Appendix B program (or ASME NQA-1 program). In embodiments, the revise/supplement tool 1135 may provide the documents to, e.g., the organization using, for example, hyperlinks, email, postal mail or any other suitable delivery method.

### Flow Diagram

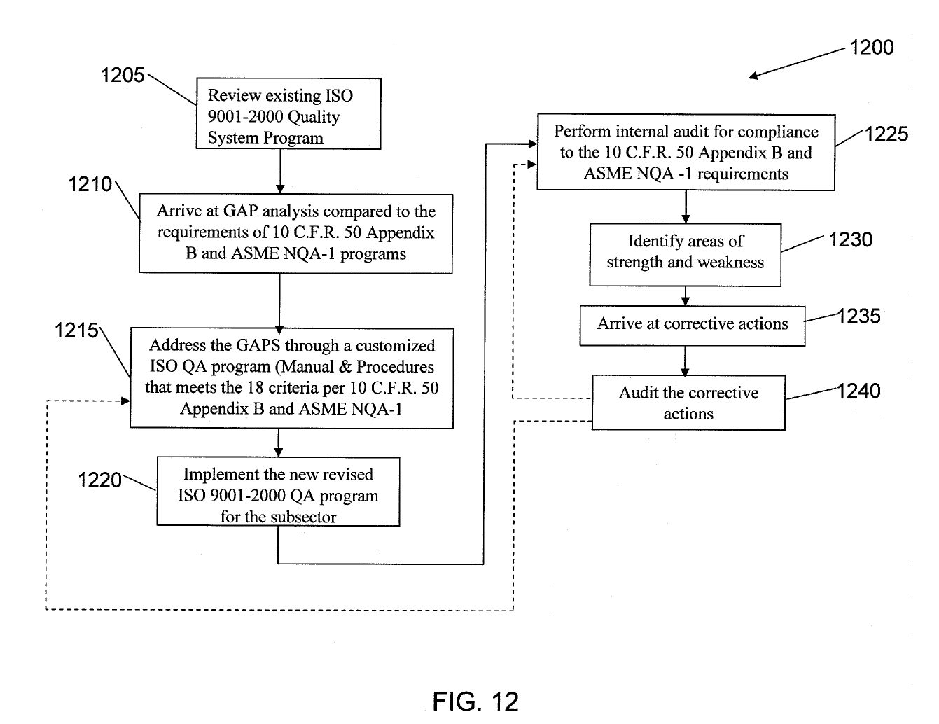

FIG. 12 shows an exemplary flow diagram 1200 in accordance with aspects of the invention. The steps of FIG. 12 may be implemented in the environment of FIG. 11, for example. The flow diagram may equally represent a high-level block diagram of the invention. It should also be noted that, in some alternative implementations, the functions noted in the blocks may occur out of the order noted in the figure. For example, two blocks shown in succession may, in fact, be executed substantially concurrently, or the blocks may sometimes be executed in the reverse order, depending upon the functionality involved.

Blocks of the flow diagram can be implemented by special purpose hardware-based systems that perform the specified functions or acts, or combinations of special purpose hardware and computer instructions and/or software, as described above. Moreover, the steps of the flow diagram may be implemented and executed from either a server, in a client server relationship, or they may run on a user workstation with operative information conveyed to the user workstation.

The flowchart and/or block diagram in FIG. 12 illustrates the architecture, functionality, and operation of possible implementations of systems, methods and computer program products according to various embodiments of the present invention. In this regard, each block in the flowchart or block diagram may represent a module, segment, or portion of code, which comprises one or more executable instructions for implementing the specified logical function(s). In embodiments, the invention can take the form of a computer program product accessible from a computer-usable or computer-readable medium providing program code for use by or in connection with a computer or any instruction execution system. The software and/or computer program product can be implemented in the environment of FIG. 11.

In embodiments, a service provider can create, maintain, deploy, support, etc., the computer infrastructure that performs the process steps of the invention for one or more customers. These customers may be, for example, any business that uses an ISO QA program. In return, the service provider can receive payment from the customer(s) under a subscription and/or fee agreement and/or the service provider can receive payment from the sale of advertising content to one or more third parties.

FIG. 12 depicts an exemplary flow 1200 for a process in accordance with aspects of the present invention. At step 1205, the existing ISO 9001-2000 quality system program is reviewed. In embodiments, the review may be performed, for example, by an auditor (e.g., internal or external) or by an organization.

At step 1210, a gap analysis is performed by comparing the requirements of 10 C.F.R. Appendix B (and ASME NQA-1) with the existing ISO 9001-2000 program. An example of the gap analysis for a fully compliant ISO 9001-2000 certified organization is shown in FIGS. 1-10. However, as noted previously, an existing ISO 9001-2000 program may have additional gaps as compared to a fully compliant ISO 9001-2000 certified organization. As such, depending upon the particular existing ISO 9001-2000 program, additional gaps may be identified. In embodiments, the gap analysis may be performed manually, e.g., by an auditor (e.g., internal or external) or by an organization. Additionally, in embodiments, the gap analysis tool may perform step 1210.

At step 1215, the identified gaps are addressed through a customization (e.g., a revision and/or supplementation) of the existing ISO program. For example, manual and procedure documents necessary to supplement the existing ISO program to meet the 18 criteria of 10 C.F.R. Appendix B (and ASME NQA-1) are identified. In embodiments, step 1215 may be performed automatically using the revise/supplement tool and the gap analysis tables 100-1000 described above. For example, the revise/supplement tool may receive an indication of the identified gaps, and may obtain the required supplemental documents (e.g., as indicated by the gap analysis tables 100-1000) from a storage system (e.g., a database) containing all of the supplemental documents for each of the 18 criteria. In embodiments, these supplemental documents may be presented to an organization, for example, using hyperlinks.

Furthermore, in embodiments, step 1215 may be performed manually using the gap analysis tables 100-1000. For example, for a given 10 C.F.R. Appendix B criteria (e.g., “organization”), the respective table identifies required “organization” criteria supplemental documents (e.g., organization, scope, organizational structure, authority/responsibilities and organizational chart). Thus, for example, an auditor may utilize the exemplary gap analysis tables to determine which documents are necessary to attain compliance with the 18 criteria of 10 C.F.R. Appendix B. In embodiments, these supplemental documents may be presented to an organization, for example, using hyperlinks, email, postal mail or any other suitable delivery method.

At step 1220, the new revised ISO 9001-2000 QA program is implemented, e.g., for the sub sector. In embodiments, step 1220 may be performed by the organization. At step 1225, the organization and/or an auditor (e.g., external and/or internal auditors) may perform an audit for compliance with the 10 C.F.R. Appendix B (and ASME NQA-1) requirements. In other words, at step 1225, a determination is made as to whether the new revised ISO program is compliant with the 10 C.F.R. Appendix B (and ASME NQA-1) requirements.

At step 1230, the audit is used to identify areas of strengths and/or weaknesses. In embodiments, step 1230 may be performed, for example, by an auditor (e.g., internal or external) or by an organization. At step 1235, the auditor identifies and implements corrective actions to address any identified weaknesses. However, the invention contemplates that, in embodiments, step 1235 may be performed in an automated fashion using a computing device and a historical database of weaknesses and their corresponding corrective action, as described above.

At step 1240, an additional audit is performed to audit the corrective actions. Furthermore, as shown in FIG. 12, optionally (as indicated by the dashed line), subsequent to step 1240, the process proceeds to step 1225 to determine whether any further corrective actions are necessary to ensure compliance of the revised ISO program with the 18 criteria of 10 C.F.R. Appendix B (and ASME NQA-1) in an iterative process. Additionally, as shown in FIG. 12, optionally (as indicated by the dashed line), subsequent to step 1240, the process proceeds to step 1215 to address any gaps in an iterative approach.

The terminology used herein is for the purpose of describing particular embodiments only and is not intended to be limiting of the invention. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method implemented in a computer infrastructure having computer executable code tangibly embodied on a computer readable storage medium having programming instructions operable to:
perform a gap analysis of an organization's ISO quality assurance (QA) program to determine a gap between requirements of the organization's ISO QA program and at least one of nuclear power plant government regulation requirements and standards organization requirements; and
create a revised ISO QA program by at least one of supplementing and revising the organization's ISO QA program to bridge the gap, such that the revised ISO QA program is compliant with the at least one of the nuclear power plant government regulation requirements and the standards organization requirements.

2. The method of claim 1, further comprising reviewing the organization's ISO QA program to ascertain the requirements of the organization's ISO QA program prior to performing the gap analysis.

3. The method of claim 1, further comprising implementing the revised ISO QA program throughout the organization.

4. The method of claim 3, further comprising:
performing at least one of an internal audit and an external audit to determine compliance of the revised ISO QA program with at least one of the nuclear power plant government regulation requirements and the standards organization requirements;
identifying areas of at least one of strength and weakness based on the at least one of the internal audit and the external audit; and
determine one or more corrective actions based on the identifying the areas of at least one of strength and weakness.

5. The method of claim 4, further comprising performing an audit of the one or more corrective actions.

6. The method of claim 5, further comprising performing at least one of an additional internal audit and an additional external audit to determine compliance of the revised ISO QA program and the one or more corrective actions with at least one of the nuclear power plant government regulation requirements and the standards organization requirements.

7. The method of claim 5, further comprising creating a further revised ISO QA program by at least one of supplementing and revising the organization's revised ISO QA program to bridge the gap, such that the further revised ISO QA program addresses the one or more corrective actions and is compliant with at least one of the nuclear power plant government regulation requirements and the standards organization requirements.

8. The method of claim 3, wherein the implementing the revised ISO QA program is at a sub sector level.

9. The method of claim 1, wherein the ISO QA program is an ISO 9001:2001 QA program.

10. The method of claim 1, wherein:
the nuclear power plant government regulation requirements comprise requirements set forth in 10 C.F.R. 50 Appendix B; and
the standards organization requirements comprise requirements set forth in American Society of Mechanical Engineers (ASME) NQA-1.

11. The method of claim 1, wherein the revised ISO QA program includes at least one of supplemental manual documents and supplemental procedure documents.

12. The method of claim 11, wherein the creating the revised ISO QA program comprises providing the organization with the at least one of the supplemental manual documents and the supplemental procedure documents.

13. The method of claim 12, wherein the providing is via a hyperlink to the at least one of the supplemental manual documents and the supplemental procedure documents.

14. The method of claim 1, wherein the determining the gap comprises at least one of determining an existence of the gap; and determining an extent of the gap.

15. The method of claim 1, wherein the performing the gap analysis comprises receiving inputs in response to one or more questions.

16. The method of claim 1, further comprising generating a gap report.

17. The method of claim 1, wherein a service provider at least one of creates, maintains, deploys and supports the computer infrastructure.

18. The method of claim 1, wherein steps are provided by a service provider on a subscription, advertising, and/or fee basis.

19. A system implemented in hardware, comprising:
a gap analysis tool operable to perform a gap analysis of an organization's ISO quality assurance (QA) program to determine an existence of a gap between requirements of the organization's ISO QA program and at least one of nuclear power plant government regulation requirements and standards organization requirements, and an extent of the gap; and
a revise/supplement tool operable to create a revised ISO QA program by at least one of supplementing and revising the organization's ISO QA program to bridge the gap, such that the revised ISO QA program is compliant with the at least one of the nuclear power plant government regulation requirements and the standards organization requirements.

20. The system of claim 19, wherein the implementing the revised ISO QA program is at a sub sector level.

21. The system of claim 19, wherein the revised ISO QA program includes at least one of supplemental manual documents and supplemental procedure documents; and the revise/supplement tool is further operable to provide the organization with the at least one of the supplemental manual documents and the supplemental procedure documents.

22. The system of claim 19, wherein:
the nuclear power plant government regulation requirements comprise requirements of 10 C.F.R. 50 Appendix B; and
the standards organization requirements comprise requirements of American Society of Mechanical Engineers (ASME) NQA-1.

23. A computer program product comprising a computer usable storage medium having readable program code embodied in the storage medium, the computer program product includes at least one component operable to:
perform a gap analysis of an organization's ISO quality assurance (QA) program to determine a gap between requirements of the organization's ISO QA program and at least one of nuclear power plant government regulation requirements and standards organization requirements; and
create a revised ISO QA program by at least one of supplementing and revising the organization's ISO QA program with at least one of a supplemental manual document and a supplemental procedure document to bridge the gap, such that the revised ISO QA program is compliant with the at least one of the nuclear power plant government regulation requirements and the standards organization requirements.

24. The computer program product of claim 23, wherein:
the nuclear power plant government regulation requirements comprise requirements of 10 C.F.R. 50 Appendix B; and
the standards organization requirements comprise requirements of American Society of Mechanical Engineers (ASME) NQA-1.

25. The computer program product of claim 23, wherein the at least one component operable to perform the gap analysis comprises the at least one component operable to receive inputs in response to a questionnaire.

26. The computer program product of claim 25, wherein the at least one component operable to perform the gap analysis is operable to analyze the receive inputs in response to the questionnaire to determine the gap.

27. The computer program product of claim 23, further comprising the at least one component operable to generate a gap report.
